(19) United States
(12) Patent Application Publication
(10) Pub. No.: US 2026/0149987 A1
(43) Pub. Date: May 28, 2026

(54) MODEL GENERATION DEVICE, AND MODEL GENERATION METHOD, AND MODEL GENERATION PROGRAM

(71) Applicant: Nippon Telegraph and Telephone Corporation, Tokyo (JP)

(72) Inventors: Hisashi NAGATA, Musashino-shi, Tokyo (JP); Riichi KUDO, Musashino-shi, Tokyo (JP); Kahoko TAKAHASHI, Musashino-shi, Tokyo (JP); Tomoaki Ogawa, Musashino-shi, Tokyo (JP)

(21) Appl. No.: 19/123,439

(22) PCT Filed: Nov. 11, 2022
(86) PCT No.: PCT/JP2022/042108

§ 371 Date: Apr. 23, 2025

(51) Int. Cl. H04W 24/06; G06N 20/00

(52) U.S. Cl. CPC H04W 24/06; G06N 20/00

(57) ABSTRACT

A moving unit (10), an acquisition unit (12), a communication unit (11), a generation unit (14), an evaluation unit (15), and a designation unit (16) are included. The acquisition unit (12) acquires physical space information with respect to around the moving unit, the communication unit (11) acquires a communication quality of the moving unit (10) or a communication terminal (21) installed around the moving unit (10), the generation unit (14) performs machine learning on the basis of the communication quality and the physical space information to generate a prediction model that associates the physical space information with the communication quality, the evaluation unit (15) evaluates a prediction result of the prediction model on the basis of the prediction result and an actual measured value of the communication quality, and the designation unit (16) designates a movement condition of the moving unit (10) on the basis of an evaluation result from the evaluation unit (15).

### TECHNICAL FIELD

The present disclosure relates to a model generation device, a model generation method, and a model generation program.

### BACKGROUND ART

In a case where wireless communication is performed using a communication device, a communication quality changes according to a change in environment such as movement of an object present around the communication device. Due to a change in the environment, it is possible that the service provided by the communication device or the communication quality required by the system may no longer be satisfied.

For example, in 5th generation communication (5G communication) such as “IEEE 802.11ad” and cellular communication, since a frequency having a high wavelength in a millimeter band is used, blocking due to a shielding object during transmission and reception of wireless communication greatly affects a communication quality.

If the communication quality can be predicted in advance, it may be possible to take measures before the service or the system is affected. Non Patent Literature 1 and 2 disclose prediction of a communication quality at the time of blocking a wireless communication line of millimeter wave communication due to passage of an object using physical space information acquired from a depth camera.

### CITATION LIST

### Non Patent Literature

Non Patent Literature 1: T. Nishio, H. Okamoto, K. Nakashima, Y. Koda, K. Yamamoto, M. Morikura, Y. Asai, and R. Miyatake, “Proactive Received Power Prediction Using Machine Learning and Depth Images for mmWave Networks,” IEEE Journal on Selected Areas in Communications, vol. 37, no. 11, pp. 2413-2427, November 2019. doi: 10.1109/JSAC.2019.2933763.
Non Patent Literature 2: H. Okamoto et al., “Machine-learning-based throughput estimation using images for mmWave communications,” in Proc., IEEE VTC 2017-spring, January 2017.

### SUMMARY OF INVENTION

### Technical Problem

However, in the above-mentioned Non Patent Literature 1 and 2, when a model of the wireless communication quality is generated, a person participates in an experiment and collects data necessary for prediction of the wireless communication quality. For example, since data is collected by performing an action such as a person carrying a communication terminal and walking, or a person wearing a VR device and walking, there is a problem that much human labor is required.

Additionally, because people move in a variety of different ways, there is a problem that it is difficult to collect data that takes these variations into account. For this reason, there is a likelihood that the data becomes insufficient and the prediction accuracy is partially lowered.

The present disclosure has been made in view of the above circumstances, and an object of the present disclosure is to provide a model generation device, a model generation method, and a model generation program capable of collecting data and generating a prediction model with reduced human labor.

### Solution to Problem

According to one aspect of the present disclosure, there is provided a model generation device including: a moving unit; an information acquisition unit that acquires physical space information with respect to around the moving unit; a communication quality acquisition unit that acquires a communication quality of the moving unit or a communication terminal installed around the moving unit; a generation unit that performs machine learning on the basis of the communication quality and the physical space information to generate a prediction model that associates the physical space information with the communication quality; an evaluation unit that evaluates a prediction result of the prediction model on the basis of the prediction result and an actual measured value of the communication quality; and a designation unit that designates a movement condition of the moving unit on the basis of an evaluation result from the evaluation unit.

According to another aspect of the present disclosure, there is provided a model generation method including: acquiring physical space information with respect to around a moving unit; acquiring a communication quality of the moving unit or a communication terminal installed around the moving unit; performing machine learning on the basis of the communication quality and the physical space information to generate a prediction model that associates the physical space information with the communication quality; evaluating a prediction result of the prediction model on the basis of the prediction result and an actual measured value of the communication quality; and designating a movement condition of the moving unit on the basis of an evaluation result.

According to still another aspect of the present disclosure, there is provided a model generation program for causing a computer to function as the above model generation device.

### Advantageous Effects of Invention

According to the present disclosure, it is possible to collect data and generate a prediction model with reduced human labor.

### BRIEF DESCRIPTION OF DRAWINGS

FIG. 1 is a block diagram illustrating configurations of a model generation device according to an embodiment and its peripheral devices.

FIG. 2 is a perspective view illustrating a configuration of a moving unit.

FIG. 3 is a flowchart illustrating a processing procedure for generating a prediction model by the model generation device according to the embodiment.

FIG. 4 is a flow diagram illustrating a flow of generating a prediction model for predicting a communication quality on the basis of physical space information of a moving unit and a communication quality of a communication terminal.

FIG. 5 is a graph illustrating an estimation result when five hours' worth of robot data and five minutes' worth of human data are prepared and a test is performed using a prediction model trained using the robot data and the human data.

FIG. 6 is a graph illustrating a measured value and an estimated value of throughput estimated using 19 hours' worth of robot data and five minutes' worth of human data.

FIG. 7 is a block diagram illustrating configurations of a model generation device according to a first modification example and its peripheral devices.

FIG. 8 is a block diagram illustrating configurations of a model generation device according to a second modification example and its peripheral devices.

FIG. 9 is a block diagram illustrating configurations of a model generation device according to a third modification example and its peripheral devices.

FIG. 10 is a block diagram illustrating configurations of a model generation device according to a fourth modification example and its peripheral devices.

FIG. 11 is a block diagram illustrating a hardware configuration of the present embodiment.

### DESCRIPTION OF EMBODIMENTS

### Description of Embodiment

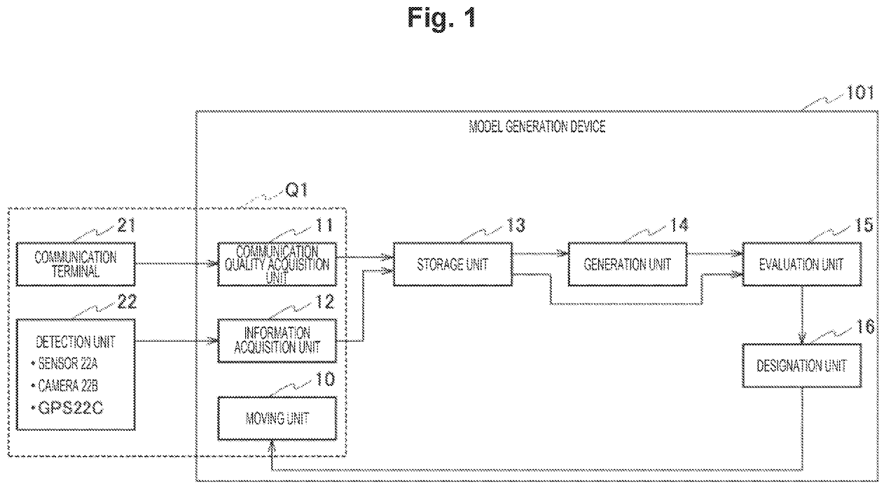

Hereinafter, an embodiment will be described with reference to the drawings. FIG. 1 is a block diagram illustrating configurations of a model generation device according to an embodiment and its peripheral devices. As illustrated in FIG. 1, a model generation device 101 according to the embodiment includes a moving unit 10, a communication quality acquisition unit 11, an information acquisition unit 12, a storage unit 13, a generation unit 14, an evaluation unit 15, and a designation unit 16.

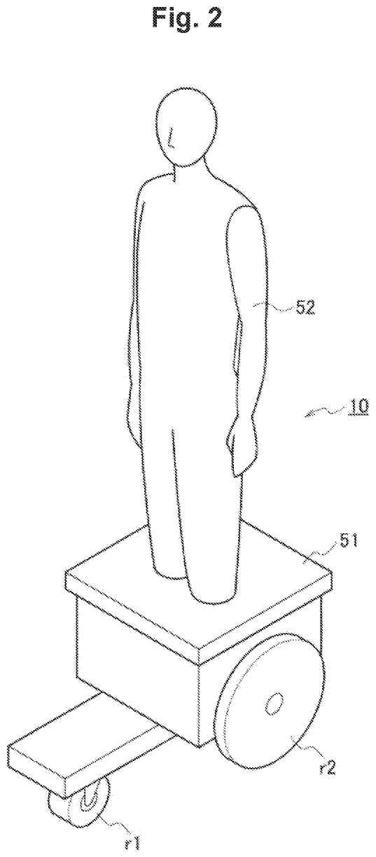

The moving unit 10 is movable on a floor surface, and moves on the floor surface along a traveling route input by a user or a traveling route designated by the designation unit 16 (details will be described later). For example, as illustrated in FIG. 2, the moving unit 10 includes a cart 51 on which wheels r1 and r2 are mounted and capable of traveling on a road, and a robot 52 installed on an upper surface of the cart 51. The robot 52 is designed to simulate a human. The relative dielectric constant and electrical conductivity of the robot 52 are designed to be close to those of the human body. The moving unit 10 is provided with a communication terminal 21 and a detection unit 22, which will be described later.

The robot 52 is capable of moving in a manner that simulates the movements of a human being with its right hand, left hand, head, and torso. For example, the communication terminal 21 can be held in the right hand.

The moving unit 10 may have another configuration as long as it has a configuration other than the robot 52 that can reproduce the scenario to be predicted. The scenario to be predicted includes a walking scene, a scene in which virtual reality (VR) is used while wearing goggles, and the like. The moving unit 10 may be configured not to include the cart 51 as long as it can substitute for a human body. In addition, the combination of the cart 51 and the robot 52 may not be used, and any configuration may be used as long as it can collect data instead of a person, such as preparing a human body model capable of bipedal walking and allowing the human body model to walk by itself.

The communication terminal 21 illustrated in FIG. 1 is, for example, a smartphone, a tablet terminal, or a personal computer (PC), and can perform voice calls, data communications, and the like.

The detection unit 22 detects physical space information of the robot 52. The physical space information includes information on the position, speed, and acceleration of a part (hand, shoulder, head, etc.) of the robot 52. The physical space information includes information on an obstacle and a moving object present around the moving unit 10.

The detection unit 22 includes at least one of a sensor 22A, a camera 22B, and a GPS receiver 22C. The sensor 22A detects the position, speed, and acceleration of the part of the robot 52, and a combination thereof.

The sensor 22A is, for example, a three-dimensional position sensor, a speed sensor, and an acceleration sensor. The sensor 22A detects the position, speed, and acceleration of the part of the robot 52.

The camera 22B captures an image of the robot 52, analyzes the captured image, and detects the position, speed, and acceleration of the part of the robot 52. The camera 22B captures a surrounding image of the robot 52, analyzes the captured image, and detects a stationary object and a moving object present around the robot 52.

The GPS receiver 22C acquires GPS information of the communication terminal 21 through communication with a GPS satellite.

The communication quality acquisition unit 11 is connected to the communication terminal 21 in a wireless or wired manner. The communication quality acquisition unit 11 may be integrated with the communication terminal 21. The communication quality acquisition unit 11 acquires a communication quality when the communication terminal 21 is communicating with an external device via a network. The communication quality is, for example, bandwidth throughput, a received signal strength indicator (RSSI) representing a received signal strength of radio waves, a reference signal received power (RSRP) representing a radio wave strength of a base station, a reference signal received quality (RSRQ) representing a received strength of radio waves, and signal to interference and noise (SINR) representing a received quality of a signal. The larger these numerical values are, the higher the communication quality is. In addition, the communication quality includes a time required for downloading data. The shorter the time is, the higher the communication quality is.

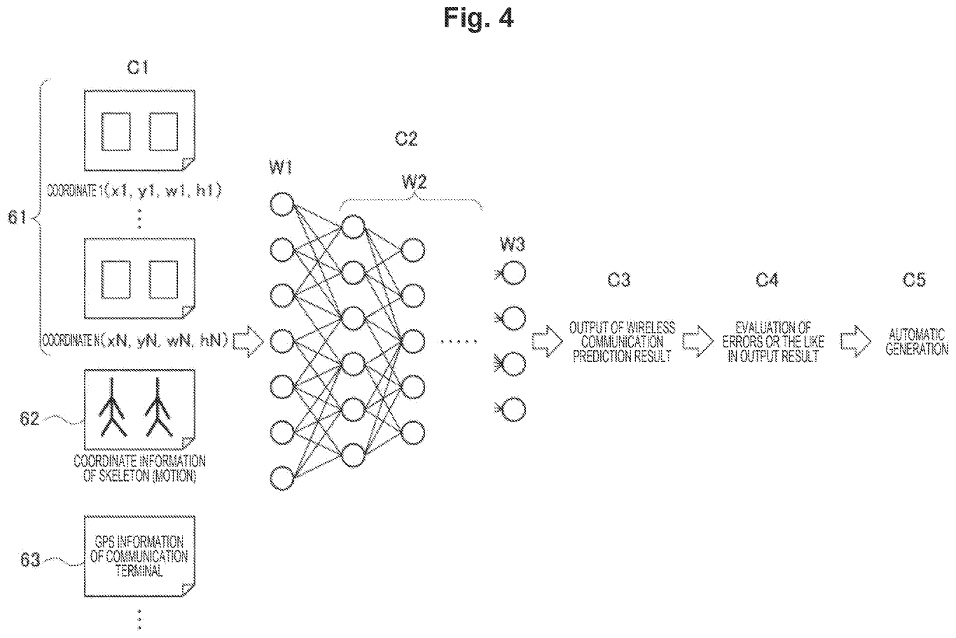

The information acquisition unit 12 acquires physical space information of the moving unit 10 detected by the detection unit 22. The information acquisition unit 12 classifies the physical space information for each category, creates a database to be input to the model of the prediction model of the wireless communication quality prediction, and uses the database as learning data of the prediction model of the wireless communication quality prediction. The category includes a bounding box 61, skeleton coordinate information 62, GPS information of the communication terminal 21, and the like illustrated in C1 of FIG. 4, which will be described later. Note that components illustrated in a frame of reference sign Q1 illustrated in FIG. 1 are mounted on the moving unit 10 and move together with the moving unit 10.

The storage unit 13 includes a storage medium such as a hard disk, for example, and stores the communication quality acquired by the communication quality acquisition unit 11 and the physical space information acquired by the information acquisition unit 12.

The generation unit 14 performs machine learning on the basis of the communication quality and the physical space information stored in the storage unit 13, thereby generating a prediction model with the physical space information as an input and the communication quality as an output. That is, the generation unit 14 performs machine learning on the basis of the communication quality and the physical space information, and associates the physical space information with the communication quality.

The evaluation unit 15 compares the prediction result from the prediction model generated by the generation unit 14 with the communication quality and the physical space information stored in the storage unit 13 to evaluate the accuracy of the prediction model. That is, the evaluation unit 15 evaluates the prediction result on the basis of the prediction result of the prediction model and the actual measured value of the communication quality.

The designation unit 16 designates a movement condition of the moving unit 10 on the basis of the evaluation result from the evaluation unit 15. The designation unit 16 outputs an instruction to intensively move in an area where the evaluation of the prediction model is lower than a predetermined value to the moving unit 10 on the basis of the result of the evaluation unit 15 evaluating the prediction model generated by the generation unit 14. The designation unit 16 designates at least one of an area where the user of the communication terminal 21 can operate and an area where the frequency of operation of the user is higher than a predetermined value as a movement route on which the moving unit 10 moves.

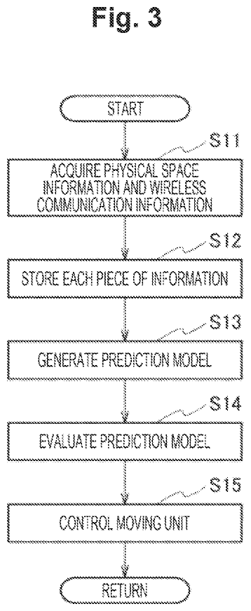

Next, the operation of the model generation device 101 according to the present embodiment described above will be described with reference to FIGS. 3 and 4. FIG. 3 is a flowchart illustrating a processing procedure for generating a prediction model of the communication quality, and FIG. 4 is a flow diagram illustrating a flow of generating a prediction model of the communication quality using the physical space information of the moving unit 10 and the communication quality of the communication terminal 21 as inputs.

First, in step S11 illustrated in FIG. 3, the communication quality acquisition unit 11 acquires a communication quality when the communication terminal 21 is communicating with an external device via a network. Furthermore, the information acquisition unit 12 acquires physical space information of the moving unit 10.

For example, as illustrated in C1 of FIG. 4, the position, speed, and acceleration of the part of the robot 52 are detected from the coordinates of the image in the bounding box and changes in the coordinates. Furthermore, position information of the hand, head, and torso of the robot 52 is detected on the basis of the coordinate information of the skeleton.

The sensor 22A detects skeleton coordinate information 62 illustrated in C1 of FIG. 4 as an example. As an example, the camera 22B detects information of the bounding box 61 that changes in time series illustrated in C1 of FIG. 4. The GPS receiver 22C acquires GPS information 63 illustrated in C1 of FIG. 4, for example. These pieces of data are output to the information acquisition unit 12.

In step S12, the storage unit 13 stores the physical space information acquired by the information acquisition unit 12, the communication quality acquired by the communication quality acquisition unit 11, and the GPS information.

In step S13, the generation unit 14 generates a prediction model on the basis of the communication quality and the physical space information stored in the storage unit 13, with the physical space information as an input and the communication quality as an output. As illustrated in “C2” of FIG. 4, the generation unit 14 generates a prediction model for estimating the communication quality using the physical space information as an input using a neural network including an input layer W1, at least one intermediate layer W2, and an output layer W3.

In step S14, the evaluation unit 15 compares the estimation result using the prediction model generated by the generation unit 14 with the communication quality and the physical space information stored in the storage unit 13, and evaluates the accuracy of the prediction model on the basis of indices such as both errors. That is, it is determined whether or not the accuracy of the estimation result from the prediction model generated by the generation unit 14 is higher than a predetermined value.

In step S15, the designation unit 16 designates a traveling path on which the moving unit 10 moves. Specifically, the traveling path is designated to intensively travel in an area where the evaluation by the evaluation unit 15 is lower than a predetermined value and in an area where the surrounding environment has greatly changed. As a result, a communication quality and physical space information can be acquired at points where the prediction accuracy is lower than a predetermined value, and the accuracy of the prediction model can be improved. Thereafter, the process is repeated from step S11.

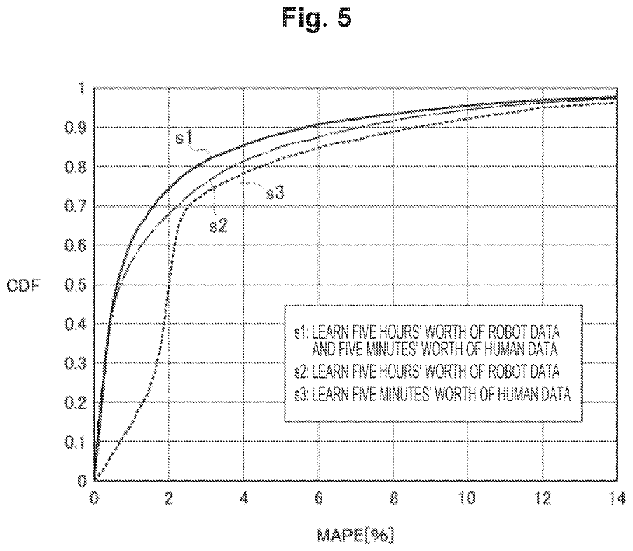

FIG. 5 is a graph illustrating an estimation result when five hours' worth of data acquired using a robot (hereinafter referred to as “robot data”) and five minutes' worth of data acquired by actually carrying the communication terminal 21 by a person (hereinafter referred to as “human data”) are prepared along a scenario of straight walking and a test is performed using a prediction model trained using the robot data and the human data. In FIG. 5, the horizontal axis represents a mean absolute percentage error (MAPE), and the vertical axis represents a cumulative distribution function (CDF).

A curve s1 indicates an estimation result when five hours' worth of robot data and five minutes' worth of human data are used, a curve s2 indicates an estimation result when only five hours' worth of robot data is used, and a curve s3 indicates an estimation result when only five minutes' worth of human data is used.

For curves s1, s2, and s3 in FIG. 5 where the MAPE is 2%, the CDFs are 75, 68%, and 50%, respectively. That is, for each of the curves s1, s2, and s3, the CDFs for which the MAPE is within 2% are 75%, 68%, and 50%, respectively. For this reason, in the graph illustrated in FIG. 5, the accuracy is higher as it is on the upper left, and it is understood that a prediction model with higher accuracy can be generated by creating a prediction model using five hours' worth of robot data of the curves s1 and s2).

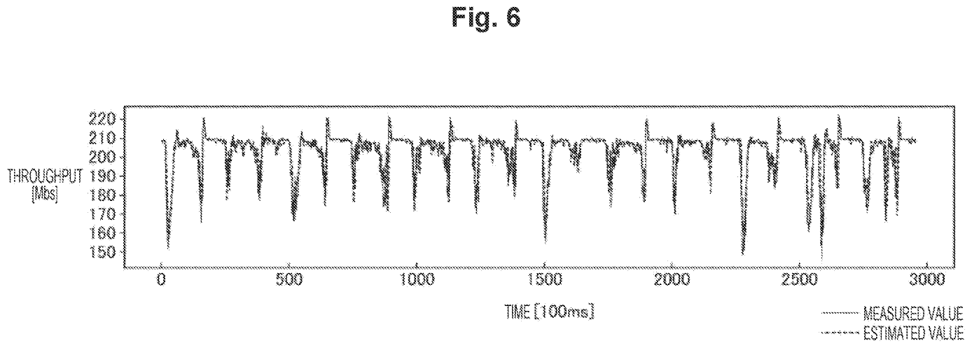

FIG. 6 is a graph illustrating the results of throughput estimated using 19 hours' worth of robot data and five minutes' worth of human data. In FIG. 6, the measured value is indicated by a solid line, and the estimated value is indicated by a broken line. As a result of estimation from the graph illustrated in FIG. 6 using the prediction model according to the present embodiment, it is understood that the estimated value substantially matches the measured value.

In this way, the model generation device 101 according to the present embodiment includes the moving unit 10, the information acquisition unit 12 that acquires physical space information with respect to around the moving unit; the communication quality acquisition unit 11 that acquires a communication quality of the moving unit 10 or the communication terminal 21 installed around the moving unit 10, the generation unit 14 that performs machine learning on the basis of the communication quality and the physical space information to generate a prediction model that associates the physical space information with the communication quality, the evaluation unit 15 that evaluates a prediction result of the prediction model on the basis of the prediction result and an actual measured value of the communication quality, and the designation unit 16 that designates a movement condition of the moving unit 10 on the basis of an evaluation result from the evaluation unit.

In the present embodiment, the robot 52 mounted on the moving unit 10 acquires physical space information and generates a prediction model. Therefore, at the time of generating the prediction model, the work of collecting the physical space information by the person carrying the communication terminal is reduced, and the work can be simplified.

In particular, movement of a person is diverse, and it is difficult to acquire data necessary for prediction of a communication quality on the basis of the movement of the person. In the present embodiment, the robot 52 mounted on the moving unit 10 is moved for a long time, and data is intensively acquired at locations where the prediction accuracy is lower than a predetermined value, whereby a highly accurate prediction model can be generated.

In addition, robot data can be used as a precise substitute for human data, making it possible to collect an enormous amount of data required for deep learning.

### Description of Modification Examples

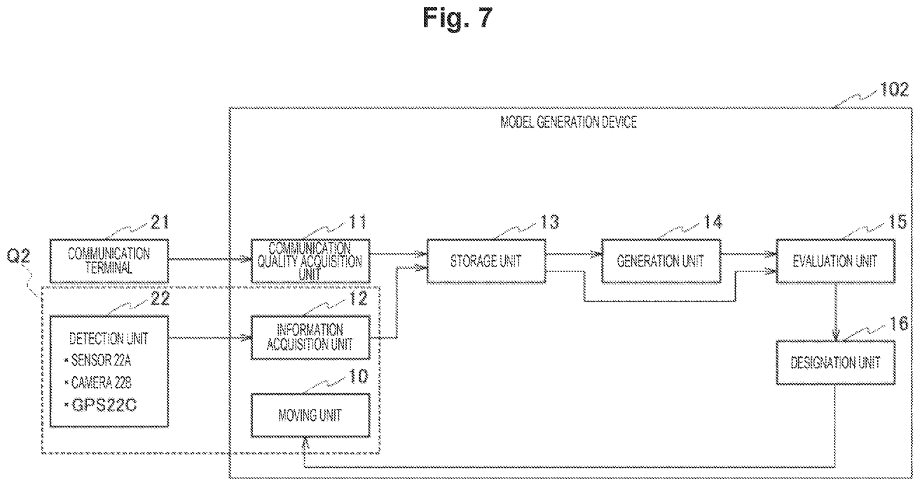

Next, modification examples of the model generation device 101 according to the above-described embodiment will be described. FIG. 7 is a block diagram illustrating a configuration of a model generation device 102 according to a first modification example. As illustrated in FIG. 7, the first modification example is different from the first embodiment described above in that the communication terminal 21 and the communication quality acquisition unit 11 are not mounted on the moving unit 10. That is, the components within reference sign Q2 are mounted on the moving unit 10 and move together with the moving unit 10.

The communication terminal 21 and the communication quality acquisition unit 11 are mounted on, for example, a control device installed in a base station that remotely operates the moving unit 10. In the model generation device 102 according to the first modification example, for example, in a case where the moving unit 10 passes near a person who is communicating using the communication terminal 21, it is possible to generate a prediction model capable of predicting the communication quality of the communication terminal 21.

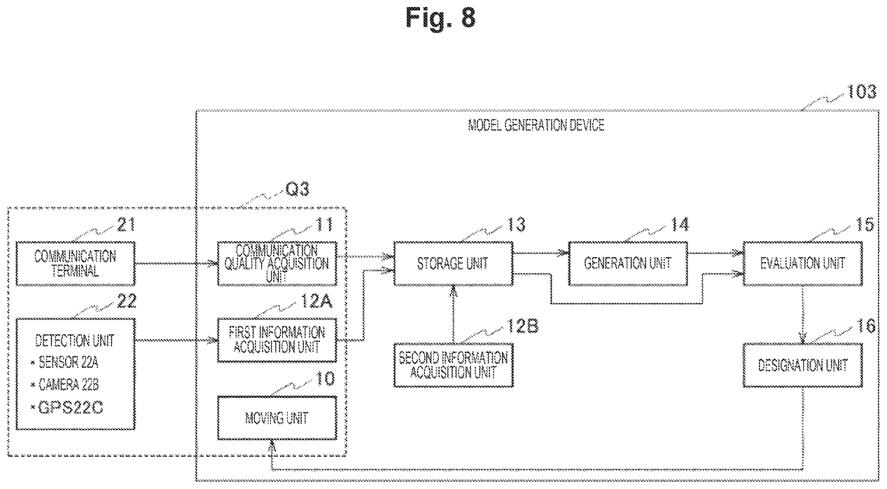

FIG. 8 is a block diagram illustrating a configuration of a model generation device 103 according to a second modification example. As illustrated in FIG. 8, the second modification example is different from the first embodiment described above in that the model generation device 103 includes a first information acquisition unit 12A and a second information acquisition unit 12B, the first information acquisition unit 12A is mounted on the moving unit 10, and the second information acquisition unit 12B is not mounted on the moving unit 10. That is, the components within reference sign Q3 are mounted on the moving unit 10 and move together with the moving unit 10.

The second information acquisition unit acquires various types of physical space information from a detection unit (not illustrated) such as a sensor or a camera installed in the vicinity of the traveling path on which the moving unit 10 travels, for example.

By including the first information acquisition unit 12A and the second information acquisition unit 12B, the physical space information in the vicinity of the moving unit 10 and the physical space information with respect to around the moving unit 10 can be acquired, and the prediction model can be generated with higher accuracy.

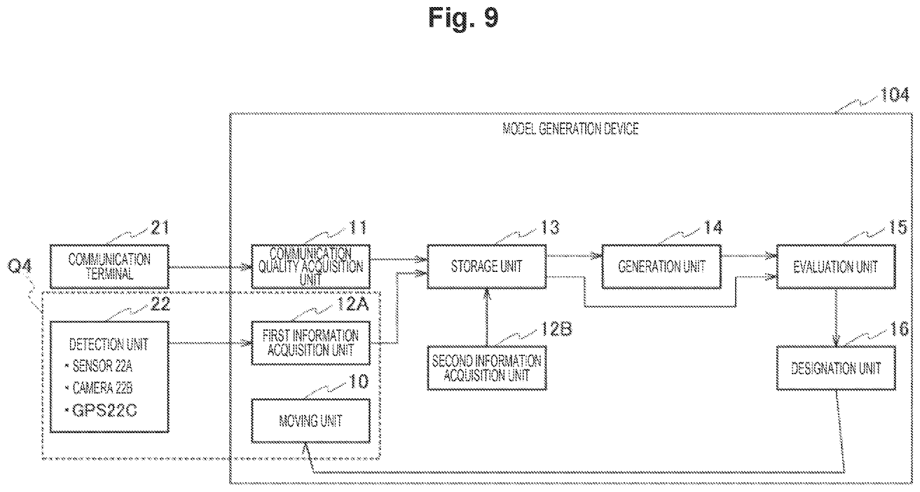

FIG. 9 is a block diagram illustrating a configuration of a model generation device 104 according to a third modification example. As illustrated in FIG. 9, the third modification example is different from the first modification example illustrated in FIG. 7 in that the model generation device 104 includes a first information acquisition unit 12A and a second information acquisition unit 12B, the first information acquisition unit 12A is mounted on the moving unit 10, and the second information acquisition unit 12B is not mounted on the moving unit 10. That is, the components within reference sign Q4 are mounted on the moving unit 10 and move together with the moving unit 10.

The second information acquisition unit 12B acquires various types of physical space information from a detection unit (not illustrated) such as a sensor or a camera installed in the vicinity of the traveling path on which the moving unit 10 travels, for example. In the model generation device 104 according to the third modification example, similarly to the first modification example, for example, in a case where the moving unit 10 passes near a person who is communicating using the communication terminal 21, it is possible to generate a prediction model capable of predicting the communication quality of the communication terminal 21.

Furthermore, similarly to the first modification example, the physical space information in the vicinity of the moving unit 10 and the physical space information with respect to around the moving unit 10 can be acquired, and the prediction model can be generated with higher accuracy.

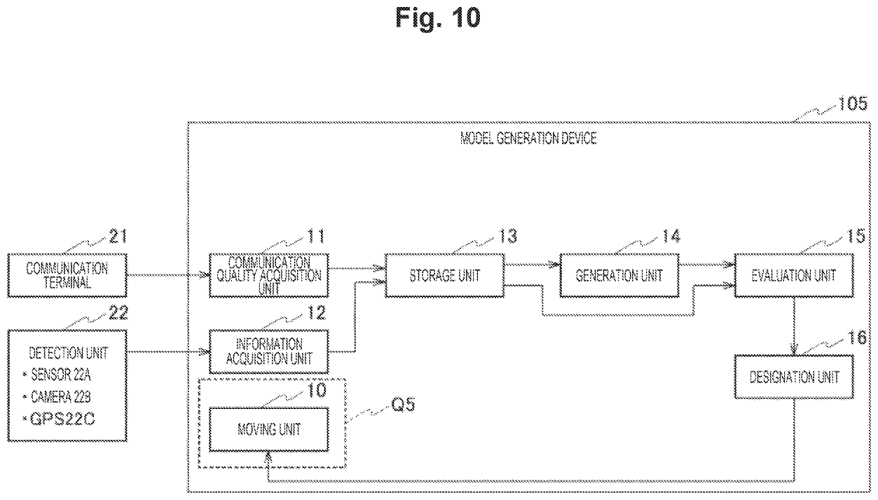

FIG. 10 is a block diagram illustrating a configuration of a model generation device 105 according to a fourth modification example. As illustrated in FIG. 10, the fourth modification example is different from the first embodiment described above in that the communication quality acquisition unit 11 and the information acquisition unit 12 are not mounted on the moving unit 10. That is, the components within reference sign Q5 are mounted on the moving unit 10 and move together with the moving unit 10.

The communication quality acquisition unit 11 is mounted on, for example, a control device installed in a base station that remotely operates the moving unit 10. The detection unit 22 and the information acquisition unit 12 are installed, for example, in the vicinity of a traveling path on which the moving unit 10 travels, and acquire various types of physical space information.

In the model generation device 105 according to the fourth modification example, only the moving unit 10 moves, and the other components do not move together with the moving unit 10. Therefore, similarly to the first and third modification examples, for example, in a case where the moving unit 10 passes near a person who is communicating using the communication terminal 21, it is possible to generate a prediction model capable of predicting the communication quality of the communication terminal 21.

Furthermore, since the communication terminal 21 and the detection unit 22 are not mounted on the moving unit 10, the configuration can be simplified.

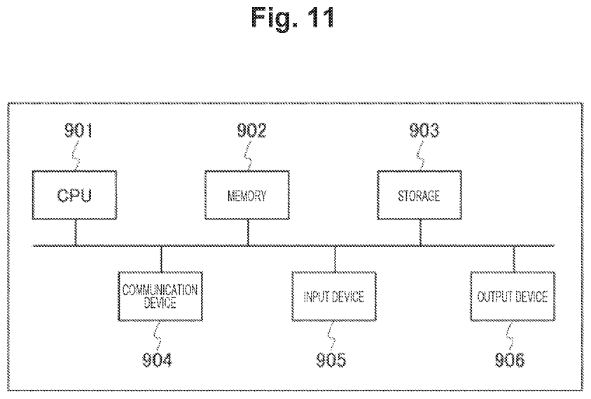

As illustrated in FIG. 11, for example, a general-purpose computer system including a central processing unit (CPU, processor) 901, a memory 902, a storage 903 (hard disk drive: HDD, solid state drive: SSD), a communication device 904, an input device 905, and an output device 906 can be used as the model generation device 101 of the present embodiment described above. The memory 902 and the storage 903 are storage devices. In this computer system, the CPU 901 executes a predetermined program loaded on the memory 902, thereby implementing each function of the model generation device 101.

The model generation device 101 may be mounted in one computer or may be mounted in a plurality of computers. In addition, the model generation device 101 may be a virtual machine that is implemented in a computer.

The program for the model generation device 101 can be stored in a computer-readable recording medium such as an HDD, an SSD, a universal serial bus (USB) memory, a compact disc (CD), or a digital versatile disc (DVD), or can be distributed via a network. Examples of the computer-readable recording medium include a non-transitory recording medium.

The present disclosure is not limited to the above embodiment, and numerous modifications are available within the scope and gist of the invention.

### REFERENCE SIGNS LIST

10 Moving unit
11 Communication quality acquisition unit
12 Information acquisition unit
12A First information acquisition unit
12B Second information acquisition unit
13 Storage unit
14 Generation unit
15 Evaluation unit
16 Designation unit
21 Communication terminal
22 Detection unit
22A Sensor
22B Camera
22C GPS receiver
51 Cart
52 Robot
61 Bounding box
62 Skeleton coordinate information
63 GPS information
101, 102, 103, 104, 105 Model generation device

1. A model generation device comprising:
a moving unit;
an information acquisition unit configured to acquire physical space information with respect to around the moving unit;
a communication quality acquisition unit, including one or more processors, configured to acquire a communication quality of the moving unit or a communication terminal installed around the moving unit;
a generation unit, including one or more processors, configured to perform machine learning on the basis of the communication quality and the physical space information to generate a prediction model that associates the physical space information with the communication quality;
an evaluation unit, including one or more processors, configured to evaluate a prediction result of the prediction model on the basis of the prediction result and an actual measured value of the communication quality; and
a designation unit, including one or more processors, configured to designate a movement condition of the moving unit on the basis of an evaluation result from the evaluation unit.

2. The model generation device according to claim 1, wherein the information acquisition unit is configured to acquire the physical space information from a camera that is mounted on the moving unit and captures an image around the moving unit and a sensor that detects at least one of a position, a speed, and an acceleration of a part of the moving unit.

3. The model generation device according to claim 1, wherein the designation unit is configured to designate at least one of an area where a user of the communication terminal is able to operate and an area where a frequency at which the user operates is higher than a predetermined value as a movement route of the moving unit.

4. The model generation device according to claim 1, wherein the designation unit is configured to designate an area where the evaluation of the prediction model is lower than a predetermined value as a movement route of the moving unit.

5. The model generation device according to claim 1, wherein the information acquisition unit includes a first information acquisition unit mounted on the moving unit and a second information acquisition unit not mounted on the moving unit.

6. A model generation method comprising:
acquiring physical space information with respect to around a moving unit;
acquiring a communication quality of the moving unit or a communication terminal installed around the moving unit;
performing machine learning on the basis of the communication quality and the physical space information to generate a prediction model that associates the physical space information with the communication quality;
evaluating a prediction result of the prediction model on the basis of the prediction result and an actual measured value of the communication quality; and
designating a movement condition of the moving unit on the basis of an evaluation result.

7. A non-transitory computer-readable storage medium storing a model generation program causing a computer to perform operations comprising:
acquiring physical space information with respect to around a moving unit;
acquiring a communication quality of the moving unit or a communication terminal installed around the moving unit;
performing machine learning on the basis of the communication quality and the physical space information to generate a prediction model that associates the physical space information with the communication quality;
evaluating a prediction result of the prediction model on the basis of the prediction result and an actual measured value of the communication quality; and
designating a movement condition of the moving unit on the basis of an evaluation result.

8. The model generation method according to claim 6, wherein acquiring physical space information comprises:
acquiring the physical space information from a camera that is mounted on the moving unit and captures an image around the moving unit and a sensor that detects at least one of a position, a speed, and an acceleration of a part of the moving unit.

9. The model generation method according to claim 6, wherein designating the movement condition comprises:
designating at least one of an area where a user of the communication terminal is able to operate and an area where a frequency at which the user operates is higher than a predetermined value as a movement route of the moving unit.

10. The model generation method according to claim 6, wherein designating the movement condition comprises:
designating an area where the evaluation of the prediction model is lower than a predetermined value as a movement route of the moving unit.

11. The model generation method according to claim 6, wherein acquiring the physical space information comprise:
acquiring the physical space information using a first information acquisition unit mounted on the moving unit and a second information acquisition unit not mounted on the moving unit.

12. The non-transitory computer-readable storage medium according to claim 7, wherein acquiring physical space information comprises:
acquiring the physical space information from a camera that is mounted on the moving unit and captures an image around the moving unit and a sensor that detects at least one of a position, a speed, and an acceleration of a part of the moving unit.

13. The non-transitory computer-readable storage medium according to claim 7, wherein designating the movement condition comprises:
designating at least one of an area where a user of the communication terminal is able to operate and an area where a frequency at which the user operates is higher than a predetermined value as a movement route of the moving unit.

14. The non-transitory computer-readable storage medium according to claim 7, wherein designating the movement condition comprises:
designating an area where the evaluation of the prediction model is lower than a predetermined value as a movement route of the moving unit.

15. The non-transitory computer-readable storage medium according to claim 7, wherein acquiring the physical space information comprise:
acquiring the physical space information using a first information acquisition unit mounted on the moving unit and a second information acquisition unit not mounted on the moving unit.
